(19) United States
(12) Patent Application Publication
(10) Pub. No.: US 2011/0102157 A1
(43) Pub. Date: May 5, 2011

(54) Wake-Up For Wireless Devices Based On Requested Data

(75) Inventor: Sasu Tarkoma, Helsinki (FI)

(73) Assignee: NOKIA CORPORATION, Espoo (FI)

(21) Appl. No.: 12/613,166

(22) Filed: Nov. 5, 2009

(51) Int. Cl. H04Q 5/22

(52) U.S. Cl. 340/10.33

(57) ABSTRACT

Various example embodiments are disclosed herein. According to an example embodiment, a method may include generating, by a first wireless communication system, a first label based on performing one or more hash functions on at least information relating to data to be requested; storing the first label in a set of one or more active labels; transmitting a data request to request the data; transitioning at least a portion of the first wireless communication system from an operational state to a low power state; receiving a message including a second label; comparing the second label to the set of one or more active labels, each of the active labels associated with an outstanding data request; determining that the second label matches one of the one or more active labels based on the comparing; and waking up at least the portion of the first wireless data communication system from the low power state back to the operational state in response to the determining.

### TECHNICAL FIELD

This description relates to wireless networks.

### BACKGROUND

Wireless devices may operate in a full-power (or operational) state to transmit and receive data, and perform other activities. From time to time, wireless devices may switch to a low-power or sleep state. Battery power may be conserved by allowing a wireless device to spend less time transmitting, and spend more time in a low power or sleep state. In some cases, wireless devices may wake and receive/process data packets that were not wanted, which may waste battery power.

### SUMMARY

According to an example embodiment, a method may include generating, by a first wireless communication system, a first label based on performing one or more hash functions on at least information relating to data to be requested; storing the first label in a set of one or more active labels; transmitting a data request to request the data; transitioning at least a portion of the first wireless communication system from an operational state to a low power state; receiving a message including a second label; comparing the second label to the set of one or more active labels, each of the active labels associated with an outstanding data request; determining that the second label matches one of the one or more active labels based on the comparing; and waking up at least the portion of the first wireless data communication system from the low power state back to the operational state in response to the determining.

According to another example embodiment, an apparatus may include: at least one processor; at least one memory including computer program code, the at least one memory and the computer program code configured to, with the at least one processor cause the apparatus to at least: generate a first label based on performing one or more hash functions on at least information relating to data to be requested; store the first label in a set of one or more active labels; transmit a data request message to request the data; and transition at least a portion of the apparatus from an operational state to a low power state; and a wake-up module, the wakeup module configured to: receive a message including a second label; compare the second label to the set of one or more active labels, each of the active labels associated with an outstanding data request; determine that the second label matches one of the one or more active labels based on the comparing; wake-up at least the portion of the apparatus from the low power state back to the operational state in response to the determining.

According to an example embodiment, a method may include: receiving a data request from a mobile station; obtaining the requested data; generating a label associated with the obtained data based on performing one or more hash functions on at least information relating to the obtained data; transmitting a wake-up message to the mobile station, the wake-up message including the label; and transmitting the obtained data to the mobile station.

According to an example embodiment, an apparatus may include: at least one processor; at least one memory including computer program code, the at least one memory and the computer program code configured to, with the at least one processor cause the apparatus to at least: receive a data request from a mobile station; obtain the requested data; generate a label associated with the obtained data based on performing one or more hash functions on at least information relating to the obtained data; transmit a wake-up message to the mobile station, the wake-up message including the label; and transmit the obtained data to the mobile station.

According to another example embodiment, a method may include: generating, by a wireless communication system, a first label based on performing one or more hash functions on at least information that describes data associated with the first label; storing the first label in a set of one or more active labels, each of the active labels associated with data, wherein a receipt of an active label will cause at least a portion of the wireless communication system to wake-up from a low power state if the portion of the wireless communication system is in a low power state; transitioning at least a portion of the first wireless communication system from an operational state to a low power state; receiving a message including a second label; comparing the second label to the set of one or more active labels; determining that the second label matches one of the one or more active labels based on the comparing; waking up at least the portion of the wireless communication system from the low power state back to the operational state in response to the determining.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a block diagram of a wireless communication system according to an example embodiment.

FIG. 3 is a block diagram illustrating a protocol stack and operation associated with transmitting a data request including a label.

FIG. 4 is a block diagram illustrating a protocol stack and operation associated with receiving a wake-up signal/message including a label associated with a data request.

FIG. 5 is diagram illustrating operation of wireless stations according to an example embodiment.

FIG. 6 is a flow chart illustrating operation of a requesting/receiving station according to an example embodiment.

FIG. 7 is a flow chart illustrating operation of a responding station according to an example embodiment.

FIG. 8 is a flow chart illustrating operation of a receiving station according to another example embodiment.

### DETAILED DESCRIPTION

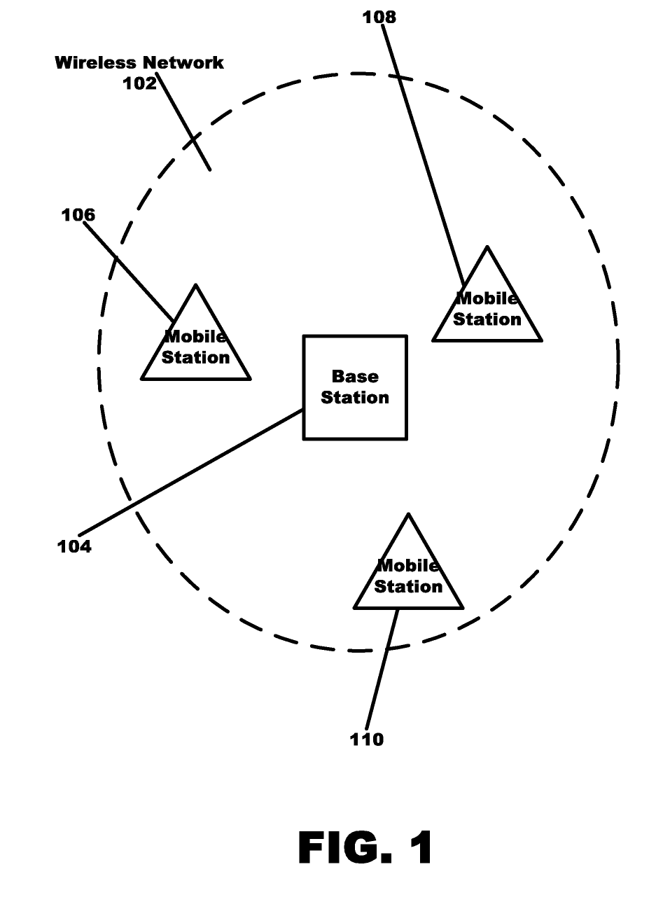

FIG. 1 is a block diagram of a wireless network 102 including a base station (BS) 104 and three (wireless) mobile stations (MSs) 106, 108, 110 according to an example embodiment. Although not shown, mobile stations 106, 108 and 110 may be coupled to base station 104 via relay stations or relay nodes, for example. The wireless network 102 may include, for example, an IEEE 802.16 Wireless Metropolitan Area Network (WiMAX), an IEEE 802.11 Wireless Local Area Network (WLAN), or a cellular telephone network, according to example embodiments, or any other wireless network. The base station (BS) 104 may include a cellular or WiMAX base station (BS), a node B, an 802.11 WLAN access point (AP), or other infrastructure node, according to various example embodiments. The term “base station” (BS) may be used herein and may include any type of infrastructure node. The mobile (or wireless) stations 106, 108, 110 may include IEEE 802.11 WLAN devices, laptop or notebook computers, smartphones, personal digital assistants (PDAs), cellular telephones, WiMAX devices, wireless subscriber stations, or any other wireless device or wireless station, according to example embodiments. The term “wireless node” may include any type of wireless node, such as base stations, mobile stations, etc. While the present disclosure may use some of the terminology of IEEE 802.11 WLAN networks or other wireless standards, aspects of the present disclosure may be applicable to any networking or wireless technologies. One or more of the example embodiments may be applied to devices that may comply with, for example, IEEE 802.11, Wireless Gigabit Alliance (WGA) standards, Long Term Evolution (LTE), WiMAX, or any other wireless standard, and may be applicable to any wireless device. These are merely a few examples and the disclosure is not limited thereto.

Although not shown in FIG. 1, two (or more) wireless (or mobile) stations may alternatively communicate directly with each other, without requiring an infrastructure node (e.g., AP, BS) therebetween. This direct communication between mobile stations may sometimes be referred to as a peer-to-peer communication, or an ad-hoc wireless network, for example. Therefore, the various embodiments and techniques described herein may be applied to mobile stations that communicate with an infrastructure node (e.g., in an infrastructure mode or the like), or directly with another mobile station (e.g., in ad-hoc mode or the like).

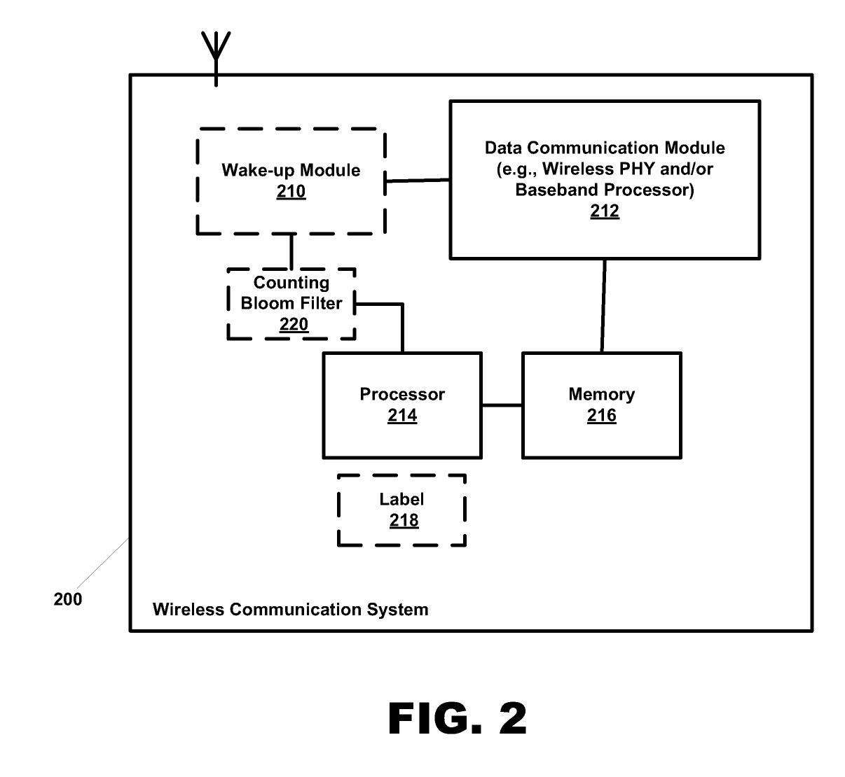

FIG. 2 is a block diagram of a wireless communication system according to an example embodiment. Wireless communication system 200 may include a data communication module 212 for transmitting and receiving information via wireless communication. For example, data communication module may be known as a wireless transceiver (transmitter/receiver), or may include a wireless PHY (physical layer interface) and a baseband processor, for example. Wireless communication system 200 may also include a wake-up module 210 (described below), a processor 214, and a memory 216. The example wireless communication system 200 may be provided at a MS, for example, although the system of FIG. 2 is merely one illustrative example, and other embodiments may be used.

The operation of wireless communication system 200 will be described as it operates on a mobile station (MS). For a MS, data communication module 212 may operate in an operational state (or full-power state) when transmitting and receiving wireless signals/data. From time to time, a portion of the communication system 200 (such as a portion of data communication module 212, processor 214, or other portion of wireless communication system 200) may transition to (or enter) a low power state to conserve power, and then may later wake-up (transition from the low power state to the operational state), e.g. to receive and/or transmit data. At least a portion of the wireless communication system 200 may be placed in a low power state, e.g., where no power, or less power is supplied to or consumed by a portion of the data communication module 212, or other portion of wireless communication system 200.

According to an example embodiment, wireless communication system 200 may include a wake-up module 210 that may selectively wake-up the portion of the wireless communication system 200 (that is in a low power state) (e.g., by outputting a wake-up signal to module 212) from the low power state back to the operational state. For example, the wake-up module 210 may cause a portion of the data communication module 212 and/or the processor 214 to wake-up, e.g., transition from low power state to operational state. By allowing at least a portion of the wireless communication system 200 to remain for periods of time in a low power state, batter power may be conserved.

In an example embodiment, wake-up module 210 may output a wake-up signal when (e.g., only when) wake-up module 210 receives a wake-up signal (such as a label associated with requested or desired data) indicating that data requested (or desired) by wireless communication system 200 will be received (or is expected) from another station (e.g., from a base station in infrastructure mode, or from another MS in peer-to-peer or ad-hoc mode). By selectively waking-up data communication module 212, for example, only when data has or will be received that was requested (or desired) by wireless communication system 200, battery power may be conserved.

In an example embodiment, a MS may generate a label based on performing one or more hash functions on at least information relating to (e.g., describing) data that will be requested or data that is desired and allowed to wake-up the portion of the communication system 200 that may be in a low power state. A label associated with data may be generated for each data request or for each type of data that will be allowed to wake-up the wireless communication system. The labels may be stored in a set of active labels, where each active label is associated with an outstanding data request, or otherwise is associated with a type of desired data that is allowed to cause a wake-up of the portion of the communication system 200 that is in a low power state. For example, a MS may receive a wake-up message that includes a label. The MS (e.g., wake-up module) may compare the received label to a set of active labels for the MS, and may wake-up the portion of the communication system 200 that may be in a low power state only if the received label matches one of the active labels. For example, a label may be generated based at least on a sender email address and stored in the set of active labels and stored in a set of active labels, where email received from the sender email address may be allowed to cause a wake-up of the communication system 200. If a label is received that matches that label (e.g., indicating that email from such sender email address will be transmitted or is attached to the wake-up message), then the portion of the communication system in low power state may be woken-up or transitioned to a full-power state. According to an example embodiment, this may allow a wake-up of the portion of the communication system in a low power state only in response to specific data or specific content.

However, once the data communication module 212 is awake (in an operational mode) in response to receiving a wake-up signal/message that includes an active label (for an outstanding data request or otherwise for data that is allowed to wake-up the communication system), the wireless communication system 200 may receive and process both requested data associated with the active label and other (non-requested) data, at least in one example embodiment. Thus, for example, using a wake-up of wireless system 200 based on requested data may defer or delay waking-up the wireless system until requested (or desired) data will be received. This may avoid situations in which the wireless system may woken-up based on receipt of non-requested data or unimportant data, such as spam email, or for other data that may not be considered high priority for the MS, according to an example embodiment.

According to an example embodiment, one or more applications on wireless communication system 200 may transmit a request for data to one or more other nodes, e.g., by unicast data request transmitted to a BS, or e.g., by a broadcast data request transmitted to other MSs in ad-hoc network or peer-to-peer mode. For example, a MS may transmit a request for a web page or for updates to a web page, e.g., by issuing or transmitting a HTTP (Hypertext Transfer Protocol) “Get” command (or other data fetch operation) to request a particular web page (e.g., identified by network address or URI (Uniform Resource Identifier)), by requesting an audio file (e.g., a MP3 audio file of a particular song or album by title or artist), a video file (e.g., video/movie based on title or actor or director, or a youtube clip by network identifier or keyword or title), a picture having a specific name or title or description, or search results corresponding to a particular search string or search criteria, email(s) from a particular sender email address or with specific word(s) in the subject line of the email, etc. These are merely a few examples of specific data that may be requested, and for which the data communication module 212 may wake-up (or transition from low power state to operational state) to receive such requested data, and the disclosure is not limited thereto. Many other types of data requests may be issued or transmitted from wireless communication system 200.

In an example embodiment, a label 218 may be generated (e.g., by MS's wireless communication system 200, such as by processor 214 or by data communication module 212). The label 218 may be associated with the data request, or may be associated with desired data that is allowed to cause or trigger a wake-up of a portion of the communication system 200 that may be in a low power state. In an example embodiment, a label may be generated, for example, based on at least information that relates to (e.g., describes) data to be requested (or describes desired data that may be allowed to wake-up a portion of the communication system that is in a low power state). For example, a label may be generated by performing one or more hash functions on at least information that describes data (e.g., that describes the data to be requested or describes the desired data that will allow a wake-up of the portion of communication system 200). The information that describes the data to be requested or the desired data that may cause a wake-up may be referred to as metadata (since this information may be data that describes other data), and may be, for example: a URI or network address (that identifies a requested/desired web page), an email address (identifying a sender email address for requested/desired emails), words or terms (e.g., present in subject line of requested/desired emails), a title of a song/album or artist (e.g., for a requested/desired audio file), title of a requested/desired movie, name or description of a requested video, name or description or network identifier (e.g., of a requested/desired youtube video clip), name or description or identifier (of a picture or other requested/desired file), search terms or a search string (corresponding to a web search for which search results are being requested).

As noted, a label may be generated based on at least information that relates to (e.g., describes) the data that is to be requested or desired to cause a wake-up the portion of the communication system or apparatus at the MS. The label may be generated, for example, based on performing one or more hash functions on at least information that relates to or describes the data. For example, a label associated with a request for emails from a sender email address may be generated by performing one or more hash functions on at least the sender email address.

The label may be based on other information or other fields as well. For example, a label may be generated based on an identifier of a sender or receiver (e.g., host identity as indicated by Host Identity Protocol, a base station ID or BSID, a mobile station ID, or other identifier), an address associated with a sender or receiver (e.g., MAC address or IP (Internet Protocol) address associated with a MS or BS or other node), and/or identification of protocols (or protocol stacks) or applications used to generate a data request and/or protocol stacks or applications (or application type) used to process the request or obtain the requested/desired data.

Many other different examples may be used for generating a label associated with a data request. In an example embodiment, a label associated with a request for a web page may be generated based on a hash function of at least the URI (or network address) of the requested web page. In another example embodiment, a label associated with a requested web search may generated based on performing one or more hash functions on at least the search terms or search string for the search. In yet another example embodiment, a label associated with a request for an audio file or song (e.g., MP3 file) may be generated based on one or more hash functions on at least the artist and title of the song. In yet another example embodiment, a label associated with a request for a video may be generated based on performing one or more hash functions on at least a title of the video/movie, for example. These are merely some illustrative examples and the disclosure is not limited thereto.

A label may be generated based on a combination of at least some information that relates to or describes the data (e.g., URI, email address, search string . . . ), and other information. For example, a label associated with a web page may be generated by performing one or more hash functions of a URI (Uniform Resource identifier) or URL, and sender and receiver MAC addresses (e.g., MAC addresses of the requesting MS and the MAC address of the responding BS/peer node), and the name “HTTP” (identifying hypertext transfer protocol) or a field within a HTTP header. In another example embodiment, a label associated with emails from a sender email address may be generated by performing a hash function of the sender email address and the MSID (mobile station ID) of requesting MS and the BSID (base station ID) of the responding BS. These are merely two illustrative examples, and many other variations or examples may be used.

As noted, according to an example embodiment, a label associated with a data request may be generated based on performing one or more hash functions on at least information relating to (e.g., describing) data to be requested (or the desired data). By using one or more hash functions, a relatively compact label may be generated, which may be efficient for transmission and storage of the label(s). Also, hashing information that relates to (e.g., describes) the data to be requested may allow for a responding station (e.g., BS) to perform a lookup into a lookup table using the label to obtain a URI, network address, etc., that may allow the receiving/responding station (e.g., BS) to retrieve or obtain the requested data based on the label, at least in some cases. In an example embodiment, a label may be generated using a Bloom filter, which may provide a particularly efficient or compact representation.

The label 218 may serve different functions within a network, depending on the application, the devices, the type of data that has been requested, etc. A label may be associated with an outstanding data request or a desired data that may cause a wake-up of the communication system. For example, a MS may have one or more (e.g., multiple) active labels, where each active label is associated with an outstanding data request or associated with a desired data. In one example embodiment, a portion of communication system 200 may wake-up upon receipt of a (wake-up) message that includes a label that matches one of the active labels for the MS. Thus, for example, wake-up module 210 may have access to a set of one or more active labels for the MS (which may be stored in memory or within wake-up module 210, as examples). When a wake-up message is received by wake-up module 210, a label provided in the wake-up message may be received by the wake-up module, and then compared to the set of one or more active labels. If the received label matches a label in the set of one or more active labels for the MS, the wake-up module 210 may output a wake-up signal to the portion of the communication system 200 (if any) that is in a low power state, which may cause this portion of the system 200 to wake-up or transition from a low power state to an operational (or full power) state to receive the data associated with the active label. The communication system may then receive the requested data.

In an example embodiment, the set of active labels for a MS may be stored (either by a MS or by a responding station such as a BS or peer MS or other node) as a counting Bloom filter 220 (FIG. 2), which may provide an efficient representation of this set of active labels. The receipt and comparison/processing of the wake-up message/signal by wake-up module 210 may be performed by a hardware circuit (e.g., wake-up module 210 may be a hardware circuit to conserve power). In some cases, wake-up module 210 may be always on, or on at least during periods when the portion of communication system 200 is in a low power (or sleep) state.

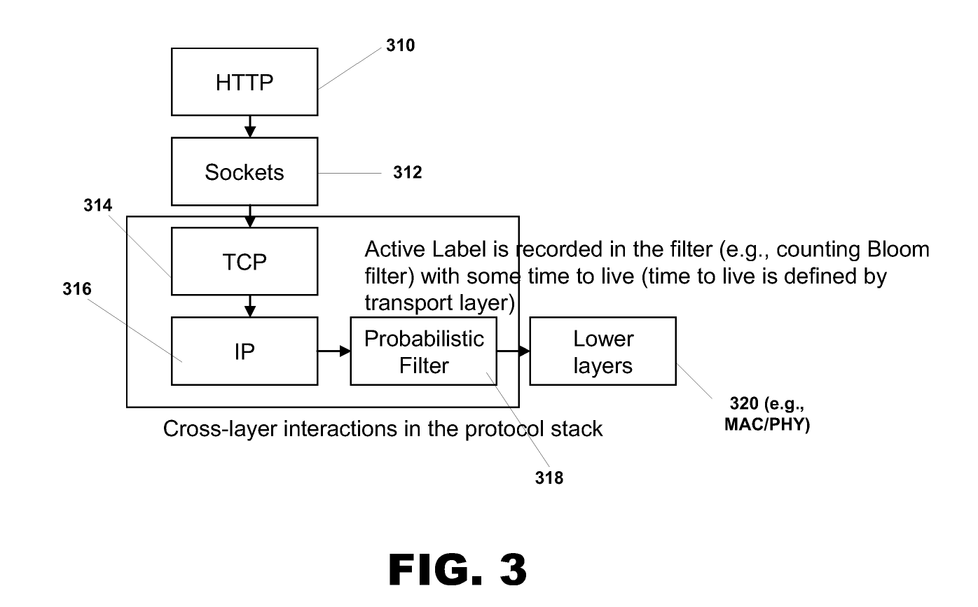

FIG. 3 is a block diagram illustrating a protocol stack and operation associated with transmitting a data request including a label. Processor 214 and/or data communication module 212 may include a protocol stack executing thereon, including several protocol blocks, such as HTTP block 310, Sockets block 312, a TCP (Transmission Control Protocol) block 314, IP (Internet Protocol) block 316, and one or more lower layers 320 (which, e.g., may include MAC or Media Access Control and PHY/Physical layer blocks). For example, the MAC/PHY may be provided within data communication module, while other protocol blocks may be run on processor 214 (FIG. 2), although this is merely one example. A data request may be generated by an application, such as a data fetch operation (e.g., fetch audio file with this song title and this artist), or an HTTP Get operation to obtain a web page. A label associated with the data request may be generated and stored by the MS. A packet (e.g., data request message), including a data identifier (e.g., URI, sender email address, search string for a web search, name of a song or video, or other identifier), may be generated by the protocol blocks and may be transmitted via wireless communication. The label 218 may be stored in a set of active labels at the MS. For example, the label for this data request may be stored in a probabilistic filter, such as a counting Bloom filter 220. For example, a Bloom filter may be considered to be a simple space-efficient randomized data structure for representing a set to support membership queries. The operation of Bloom filters are well known, and are described, for example, in: A. Broder, M. Mitzenmacher, “Network Applications of Bloom Filters: A Survey,” Internet Mathematics, Vol. I, No. 4, 485-509.

In one example embodiment, a two-step wake-up process may be used where first a wake-up message is received, and the received label compared to a set of active labels. If the label matches one of the active labels (meaning that the wake-up message is associated with data for an outstanding data request), a wake-up signal is output to wake-up the portion of the communication system (if any) that is in a low power state) to allow communication system to subsequently receive the requested data associated with the label. In an example embodiment, the data communication module may also receive other data (not just the requested data corresponding to the received label) once the data communication module is in operational or full power mode. In one example embodiment, the wake-up message is sent in a first message, and the data is sent in a second (subsequent) message. For example, the wake-up message may be provided in a first message, such as a Beacon broadcast by a BS that identifies the MS and the label. The data (including the data associated with the label in the wake-up message, and possibly other data directed to the MS) may be subsequently transmitted to the MS during a unicast downlink data transmission period, as an example.

In another example embodiment, the label may be transmitted as part of the data packet. In such case, the received packet may be considered to include both the label and the associated data. Thus, in this case, the wake-up message (including the label) and the transmitted data, are transmitted within a same message or packet, where the packet or message includes both the label and the associated data. In this latter case where both label and data may be provided within one packet or message, the wake-up module may receive the label and compare the label to the set of active labels to determine if there is a match. The wake-up module may then wake-up the portion (if any) of the communication system in a low power state and/or may forward the data portion of the packet to higher protocol layers of the communication system 200 for processing only if the received label matches one of the one or more labels in the set of active labels, according to an example embodiment.

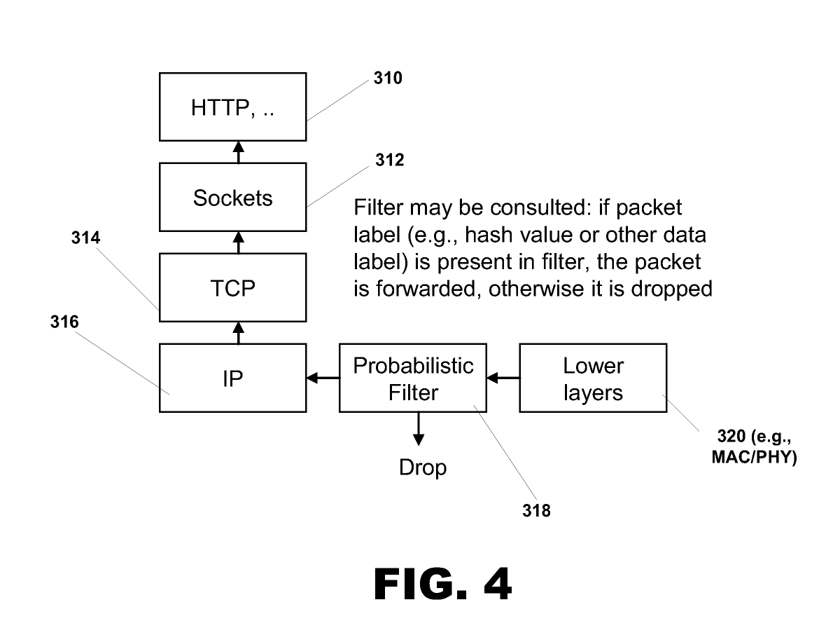

FIG. 4 is a block diagram illustrating a protocol stack and operation associated with receiving a wake-up signal/message including a label associated with a data request. When a wake-up message is received, the wake-up module may consult a set of active labels (e.g., compare received label to active labels), which may be stored as a filter such as a counting Bloom filter. The wake-up module 212 may determine whether the received label is present in the set of active labels (e.g., present in the counting Bloom filter). If the label is not present in the set of active labels, the data communication module does not wake-up to process the associated data, and in one example embodiment, the packet or message may be dropped, or may be given lower priority for processing. If the label is present in the set of active labels, then the portion of the communication system 200 that is in a low power state (e.g., portion of data communication module 212) receives a wake-up signal and wakes-up and receives and processes the received data. The data is forwarded to the protocol elements/blocks for processing.

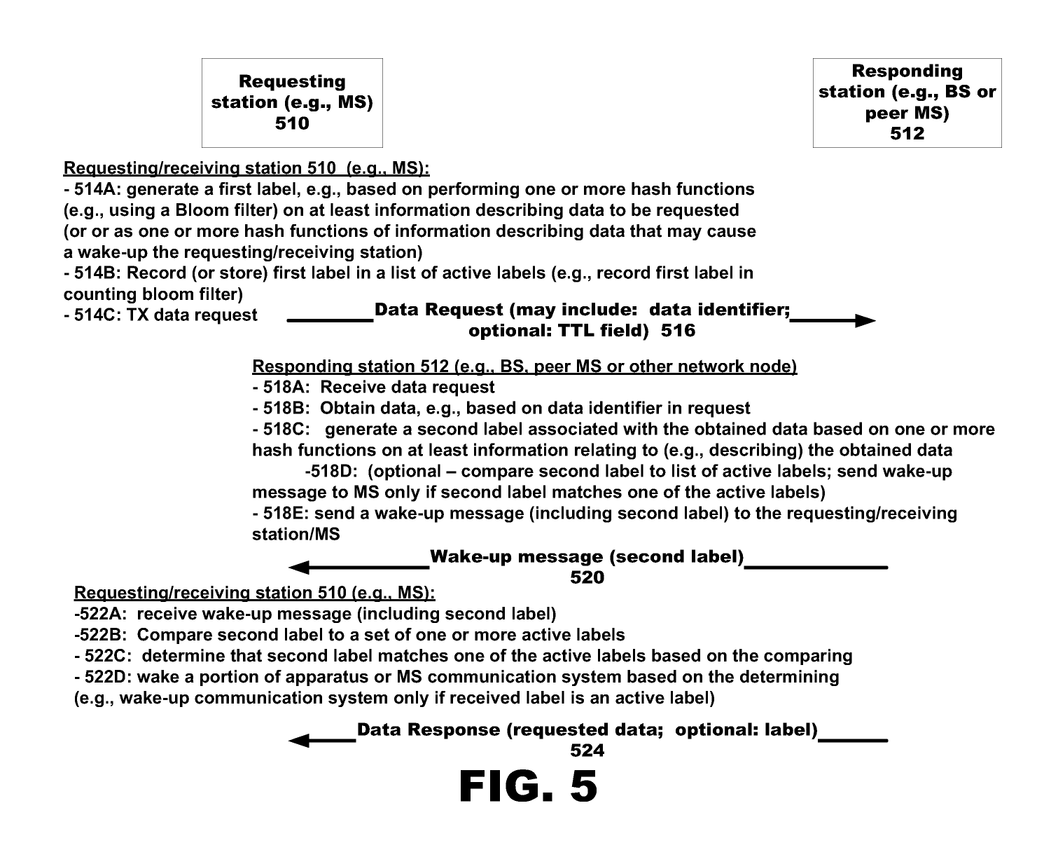

FIG. 5 is diagram illustrating operation of wireless stations according to an example embodiment. Referring to FIG. 5, a requesting/receiving station 510 (such as a MS) may be in communication with a responding station (such as a BS, or a peer MS in an ad-hoc network, or other network node). The examples described with respect to FIG. 5 will refer to responding station as a BS 512, but the responding station may also be a responding MS in an ad-hoc or peer-to-peer network, or other network node.

At 514A, requesting/receiving station 510 generates a first label based on performing one or more hash functions (e.g., using a Bloom filter) on at least information that relates to (e.g., describes) data to be requested or desired data (data that may be allowed to cause a wake-up of a portion of the communication system or MS apparatus that may be in a low power state).

At 514B, the requesting/receiving station 510 may store the first label associated with the data in a list of active labels, such as by storing the first label in a counting Bloom filter (where each active label may be associated with an outstanding or active data request or associated with data that may cause a wake-up of a portion of communication system 200 that is in a low power state).

In one example embodiment, a timer or time to live (TTL) value may be associated with each label, which may indicate a time period for which the label (or data request) will remain active. When the timer or TTL value expires, the label becomes inactive, and is removed from the set of active labels (no longer an outstanding data request for such label, or such data is no longer allowed to cause a wake-up of the portion of communication system 200 that is in a low power state). In such case (where the timer/TTL expires for a label), for example, the requesting/receiving station 510 does not want to wake-up to receive data associated with such inactive labels, so the expired label is removed from the set of active labels, and the wake-up module 210 will no longer wake-up the portion of the communication system 200 that is in a low power state in response to receiving a message that includes the inactive or expired label (or label that is not in the set of active labels).

At 514C, MS 510 transmits a data request message 516. The data request message 516 may include a data identifier that may identify the requested data. The data identifier may be, for example, a sender email address, a URI/URL of a requested web page; search terms or search string for which web search results are being requested, a network address of a web page or information stored on a server that is requested, an identifier of a text, video, graphic, audio file, name of a song or MP3 file, name of a movie, identifier or link to a Youtube video, etc. These are merely a few examples. Optionally, other fields may be included in the data request message, such as sender or receiver IDs, and sender or receiver addresses. The TTL field for the label may be included in the data request as well, e.g., to indicate a time period for which this data request will remain active.

At 518A, responding station 512 may receive the data request. At 518B, the responding station 512 may obtain the requested data, e.g., based on a data identifier including in the data request 516. A timer value (or TTL) may be recorded and tracked (counted down as time elapses) by the responding station 512, so that the responding station 512 will know when the label becomes inactive. For example, the responding station 512 may forward data that is associated with the data request, or meets or fulfills the data request so long as the label is active. When the TTL or timer for the label expires, the BS 512 may stop forwarding data associated with the data request, and may drop such data or packets, for example. A responding station 512 may receive a message from the requesting/receiving station 510 with an updated timer (or an indication to refresh or reset the timer or TTL) for a label, which will cause the timer/TTL value being tracked by the responding station 512 to be updated or refreshed accordingly, in an example embodiment. Requesting station 510 may also send a separate message (that includes a label) to the BS/responding node 512 to remove or delete a label from the set of active labels.

At 518B, the responding station 512 may obtain the requested data (or data that corresponds to or fulfills the data request). There are a number of different ways in which a station may obtain requested data. For example, data may just simply be received at the BS 512 that fulfills or meets the data request (e.g., meets the data identifier in the data request), or the BS 512 may actively retrieve and/or contact another network entity to obtain the requested data. Some examples will be briefly described with reference to FIG. 5, item 518B. In the case of a requested web search, the responding station 512 may forward the search string or search terms to another network node, e.g., a web server, data server, where the web search is performed, and the search results (e.g., top 5 results) returned to the responding node 512 (for forwarding to the requesting station 510).

At 518B, as another illustrative example, the responding station 512 may receive data that meets or fulfills the data request. For example, responding station 512 may receive an email (e.g., addressed to requesting/receiving station 510 or to an application at the requesting/receiving station 510) that has a sender email address that matches the data request 516 (e.g., matches the sender email address in the data request 516) from the requesting/receiving station 510. The responding station 512 may determine that the received email matches the data request by, for example, comparing the sender email address of the received email to a sender email address provided in the data identifier of the data request 516, e.g., where a match indicates that a wake-up message should be sent to requesting/receiving station 510, followed by the email itself.

At 518C, the responding station 512 may generate a second label associated with the obtained data based on one or more hash functions (e.g., using a Bloom filter) on at least information relating to (e.g., describing) the obtained data, such as a hash function of the sender email address of the obtain email, or a hash function of the URL/URI of the obtained web page, etc. The hash functions may also be performed on additional data, such as sender or receiver IDs (e.g., MSID, BSID), sender or receiver addresses (e.g., IP address, MAC address), and/or identification of protocols stacks or applications that may be used to retrieve or process or forward the obtained data. In an example embodiment, the generator of the second label may be the BS, or peer MS, or other node. Or the generator the second label may be a third party node or application, such as a web server, or may be a mediator, such as a BS/AP/upper level infrastructure node, as examples.

At 518D, in an alternative embodiment, the responding station 512 may store a list of active labels for each MS or requesting/receiving station 510. The responding station 512 may compare the second label associated with the obtained data to see if matches one of the labels in the set of active labels for the requesting/receiving station 510. In this example embodiment, the responding station 512 may send a wake-up message to the requesting/receiving station 510 only if the second label associated with the obtained data matches one of the labels in the set of active labels for the requesting/receiving station. If the second label matches one of the active labels, then a wake-up message followed by the obtained data may be sent to the requesting/receiving station. Otherwise, the obtained data may be dropped, or alternatively, may be held until requesting/receiving station in awake, or until a wake-up message is sent to wake-up the requesting/receiving station, e.g., based on obtained data for an active label. In this manner, the responding station 512 may receive one or more data requests from a requesting/receiving station 510, wherein the responding station 512 will send a wake-up message to the requesting/receiving station 510 (e.g., MS) while the requesting/receiving station 510 is in a low power state only for obtained data having an associated label that matches an active label for the requesting/receiving station 510 or MS. In such case, the BS or responding station 512 may selectively filter or selectively wake-up the MS or requesting/receiving station 510 only for data that is requested by requesting/receiving station 510 or for data having a label that matches a set of active labels, according to an example embodiment.

For example, email from a first sender email address, and text messages from a second number may be considered important, and thus, may have an associated label that matches a label on the set of active labels stored at the responding station. When such data is obtained, BS 512 may send a wake-up message with an associated label followed by the associated obtained data. Whereas, spam email or email from other sources or other sender email addresses (e.g., emails that are not deemed important enough to be added to the set of active labels) may either be dropped or may be held by BS 512 until MS 510 is in an operational state, and then forwarded, or may be dropped altogether, for example.

At 518E, after responding station 512 has obtained the data (518C) and generated a second label associated with the obtained data (518D), responding station 512 then may transmit a wake-up message 520, that includes the second label associated with the obtained data, to the requesting/receiving station 510 (e.g., MS). This may be done, for example, if at least a portion of communication system 200 for the requesting/receiving station 510 (e.g., MS) is currently in a low power (or sleep) state (and thus, needs to be woken up, or transition from a low power state to an operational state, to receive the data). A current state of a TTL (Time to Live field) or timer for the label may be consulted, before sending the wake-up message, to ensure that the label is still active. For example, if the TTL/timer for the label expires before the wake-up message has been sent, then the label may be removed from the responding station's set of active labels for this requesting/receiving station 510 (e.g., MS). In an example embodiment, obtained data may not be forwarded to an requesting/receiving station or MS unless the obtained data is associated with an active label (at least while the requesting/receiving station 510 is in a low power state, which may allow only certain types of data to wake-up at least a portion of the communication system 200 of requesting/receiving station or MS 510.)

The responding station 512 may have lists of active labels for each of multiple MSs (or multiple requesting/receiving stations) that may be in communication with responding station 512. A wake-up message may be any message that is received by a requesting/receiving station that may cause at least a portion of the requesting/receiving station to wake-up (transition from a low power state to an operational state), e.g., if the label in the wake-up message matches the set of active labels. Different types of messages may be used as a wake-up message. For example, responding station or BS 512 may include information in its Beacon (which may be broadcasted from time to time) that identifies the requesting/receiving station 510 and includes the label for this data request. Or, responding station 512 may transmit a unicast message to MS 510 that includes the label that may operate as a wake-up message.

At 522A, requesting/receiving station 510 (e.g., MS) may receive the wake-up message, including the second label associated with the obtained data. In an example embodiment the wake-up module 210 of MS 510 receives the wake-up message 520, which may simply be a signal that provides the label.

At 522B, the communication system 200 of requesting/receiving station 510 (e.g., MS), such as the wake-up module 210 for example, may compare the received second label to the set of active labels, which may be done using a counting Bloom filter, for example. At 522C, the requesting/receiving station, e.g., wake-up module 210, may determine that the received second label matches a label in the set of active labels, At 522D, a wake-up signal is output (e.g., from wake-up module 210 of communication system 200) to wake-up the portion of the communication system 200 that is in a low power state. This may allow a MS or requesting/receiving station 510 to perform wake-up in response to requested (or desired) data.

At 524, once in the operational state, the requesting/receiving station (e.g., MS) 510 may receive a data response 524 that may include the requested data. The data response 524 may optionally include the label, although this is not required.

The invention is expected to work well with current mobile applications that utilize client-initiated connections. With client-initiated connections, the mobile terminal first initiates a connection, and then subsequently receives data. The hash value determined in the step 3. can be based, for example, on the destination IP address and port, special Host Identifier such as that used in the Host Identity Protocol, HTTP header values, or a SIP destination URL or part of the URL. There may be one or more hash values associated with an active connection.

Example embodiments may support data and content-centric device wakeup. The desired data or desired content, or data/information describing desired data may be hashed into a label (which can be performed using a Bloom filter). A set of active labels may be stored at a MS or requesting/receiving station. At a BS or other responding node, data may be obtained, and a second hash or second label may be generated based on a description of the obtained data or based on the content of the obtained data. The BS or responding station may also store a set of active labels for the MS/requesting station. A wake-up message may be sent by the BS or responding station to the requesting/receiving station (e.g., MS), e.g., when the second label matches the set of active labels stored at the responding station. When a wake-up message is received at a MS or requesting/receiving station, the label in the received wake-up message may be compared to the set of active labels stored at the MS or requesting/receiving station. If it is determined that the label in the received wake-up message matches one of the active labels, the portion of the MS or requesting/receiving station in a low power state is woken up (or transitions from a low power state to an operational state). The data (associated with the transmitted label) is then transmitted by the BS or responding station to the requesting receiving station, where it is received and processed.

A MS or requesting/receiving station may, in another example embodiment, send a list of its active labels to the BS or responding station. Also, in one example embodiment, the MS or requesting/receiving station may send a data request to the BS that includes the label associated with the requested data.

In addition, since a wake-up module using one or more of the example embodiments may know the hash values or labels associated with requested or desired data, this information can be shared in the distributed environment. For example, a mobile client can send its currently active hash values (or set of active labels) to a base station so that the base station knows the content that the client requires and thus the BS can drop unwanted traffic (traffic or data that does not match the desired data or match the set of active labels).

A wide variety of hash functions may be used. For example, the hash functions may be implemented using any suitable hash function, for example the SHA-1 (Secure Hash Algorithm) function. The SHA hash functions are a set of cryptographic hash functions designed by the National Security Agency (NSA) and published by the NIST as a U.S. Federal Information Processing Standard. By using a hash function, or a probabilistic filter, the techniques described herein may allow desired data or desired data flows to be identified using hash values or labels, for example.

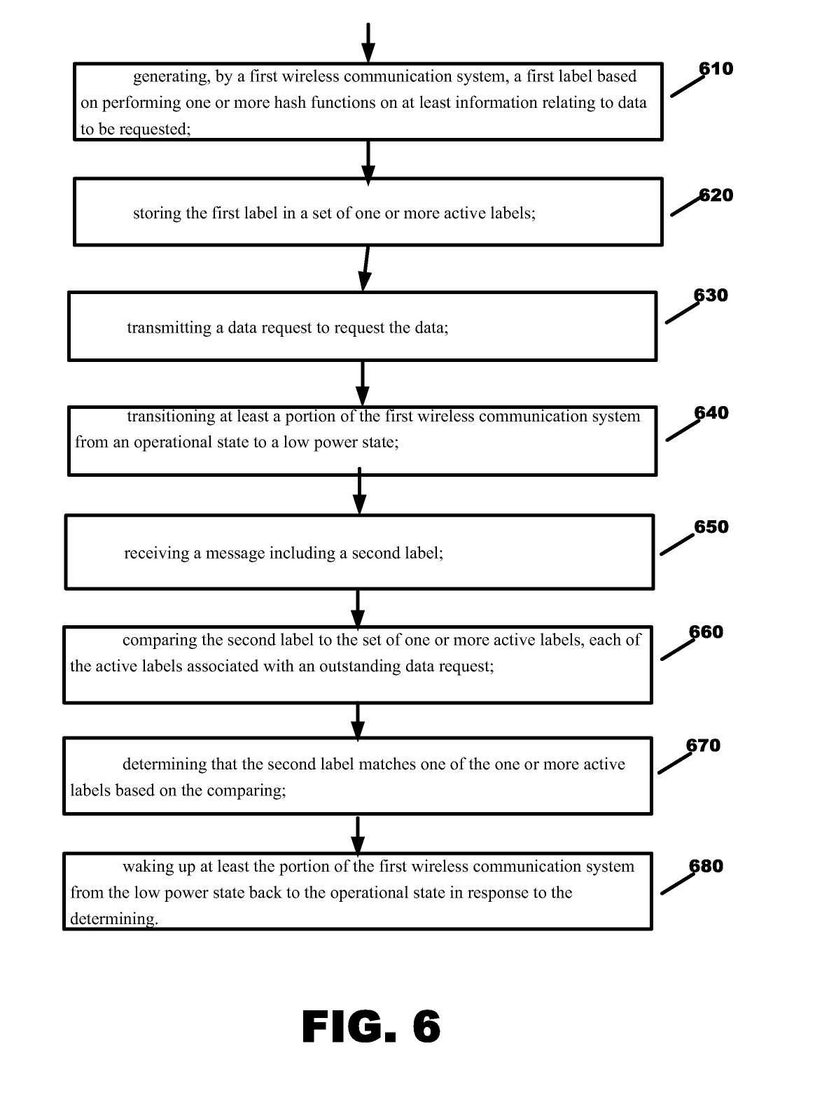

FIG. 6 is a flow chart illustrating operation of a requesting station according to an example embodiment. Operation 610 may include generating, by a first wireless communication system, a first label based on performing one or more hash functions on at least information relating to data to be requested. Operation 620 may include storing the first label in a set of one or more active labels. Operation 630 may include transmitting a data request to request the data. Operation 640 may include transitioning at least a portion of the first wireless communication system from an operational state to a low power state. Operation 650 may include receiving a message including a second label. Operation 660 may include comparing the second label to the set of one or more active labels, each of the active labels associated with an outstanding data request. Operation 670 may include determining that the second label matches one of the one or more active labels based on the comparing. Operation 680 may include waking up at least the portion of the first wireless data communication system from the low power state back to the operational state in response to the determining.

The method of FIG. 6 may further include, after the waking, receiving, via wireless communication, at least the requested data. In the method of FIG. 6, the message (e.g., wake-up message) may include the requested data. In the method of FIG. 6, the generating (610) may include: generating, by the first wireless communication system, a first label based on performing one or more hash functions using a Bloom filter on at least information relating to data to be requested.

In the method of FIG. 6, the storing (620) the first label may include storing, by the first wireless communication system, the first label in a counting Bloom filter.

In the method of FIG. 6, the receiving (650) may include receiving a wake-up message including the second label, the wake-up message indicating that data associated with the second label will be transmitted. In the method of FIG. 6, the requested data may include one or more of the following: email(s) from one or more sender email addresses; a web page from a particular address or associated with a particular URI; an audio file; a video file; or search results based on a particular search string.

In the method of FIG. 6, the generating (610) a first label may include: generating, by a first wireless communication system, a first label based on performing one or more hash functions on at least information relating to data to be requested, the information relating to data to be requested including one or more of: a sender email address; identification information for an audio, video or text file; a network address or URI (Uniform Resource Identifier) from which data is to be retrieved; or a search string for which search results are being requested.

In an example embodiment of FIG. 6, the generating (610) a first label may include: generating, by a first wireless communication system, a first label based on performing one or more hash functions on at least information relating to data to be requested and other information, the other information comprising one or more of: an identifier of a sender of the data request, or an identifier of a receiver of the data request; an address of the sender of the data request, or an address of the receiver of the data request; or an identification of one or more protocol stacks used to generate the data request.

According to an example embodiment, an apparatus may include: means for generating (e.g., wireless communication system 200, such as processor 214 and/or data communication module 212) a first label based on performing one or more hash functions on at least information relating to data to be requested, means (e.g., processor 214 and/or data communication module 212, memory 216, and/or filter 220) for storing the first label in a set of one or more active labels (e.g., processor 214 may store label in counting Bloom filter, as an example), means (e.g., wireless communication system 200, such as processor 214 and/or data communication module 212) for transmitting a data request to request the data, means (e.g., processor 214 and/or data communication module 212) for transitioning at least a portion (e.g., a portion of processor 214 and/or a portion of module 212 as examples) of the first wireless communication system (e.g., wireless communication system 200) from an operational state to a low power state, means (e.g., wake-up module 210) for receiving a message including a second label, means (e.g., wake-up module 210) for comparing the second label to the set of one or more active labels (e.g., which may be stored in counting bloom filter 220 as an example), each of the active labels associated with an outstanding data request, means (e.g., wake-up module 210) for determining that the second label matches one of the one or more active labels based on the comparing, and means (e.g., wake-up module 210) for waking up (e.g., by outputting a wake-up signal to module 212 and/or processor 214) at least the portion of the first wireless data communication system from the low power state back to the operational state in response to the determining.

The apparatus may further include means (e.g., wireless communication system 200, such as processor 214 and/or data communication module 212) for receiving (after waking), via wireless communication, at least the requested data.

According to an example embodiment, an apparatus may include: at least one processor (e.g., 214 and/or 212); at least one memory (e.g., 216) including computer program code, the at least one memory and the computer program code configured to, with the at least one processor cause the apparatus to at least: generate a first label based on performing one or more hash functions on at least information relating to data to be requested; store the first label in a set of one or more active labels; transmit a data request message to request the data; and transition at least a portion of the apparatus from an operational state to a low power state. The apparatus may also include a wake-up module (e.g., 210), the wakeup module configured to: receive a message including a second label; compare the second label to the set of one or more active labels, each of the active labels associated with an outstanding data request; determine that the second label matches one of the one or more active labels based on the comparing; wake-up at least the portion of the apparatus from the low power state back to the operational state in response to the determining.

In an example embodiment, the apparatus may be further configured to receive the requested data after the waking up at least the portion of the apparatus.

In an example embodiment, the message may further include the requested data.

In an example embodiment, wherein the at least one memory and the computer program code are configured to, with the at least one processor to cause the apparatus to generate may include being configured to cause the apparatus to: generate a first label based on performing one or more hash functions using a Bloom filter on at least information describing the data to be requested.

In an example embodiment, wherein the at least one memory and the computer program code configured to, with the at least one processor to cause the apparatus to store the first label comprises being configured to cause the apparatus to: store the first label in a counting Bloom filter.

In an example embodiment, the wakeup message may include the second label and may indicate that data associated with the second label will be transmitted.

In an example embodiment, the requested data may include one or more of the following: email(s) from one or more sender email addresses; a web page from a particular address or associated with a particular URI; an audio file; a video file; or search results based on a particular search string.

In an example embodiment, the information relating to data to be requested may include one or more of: a sender email address; identification information for an audio, video or text file; a network address or URI (Uniform Resource Identifier) from which data is to be retrieved; or a search string for which search results are being requested.

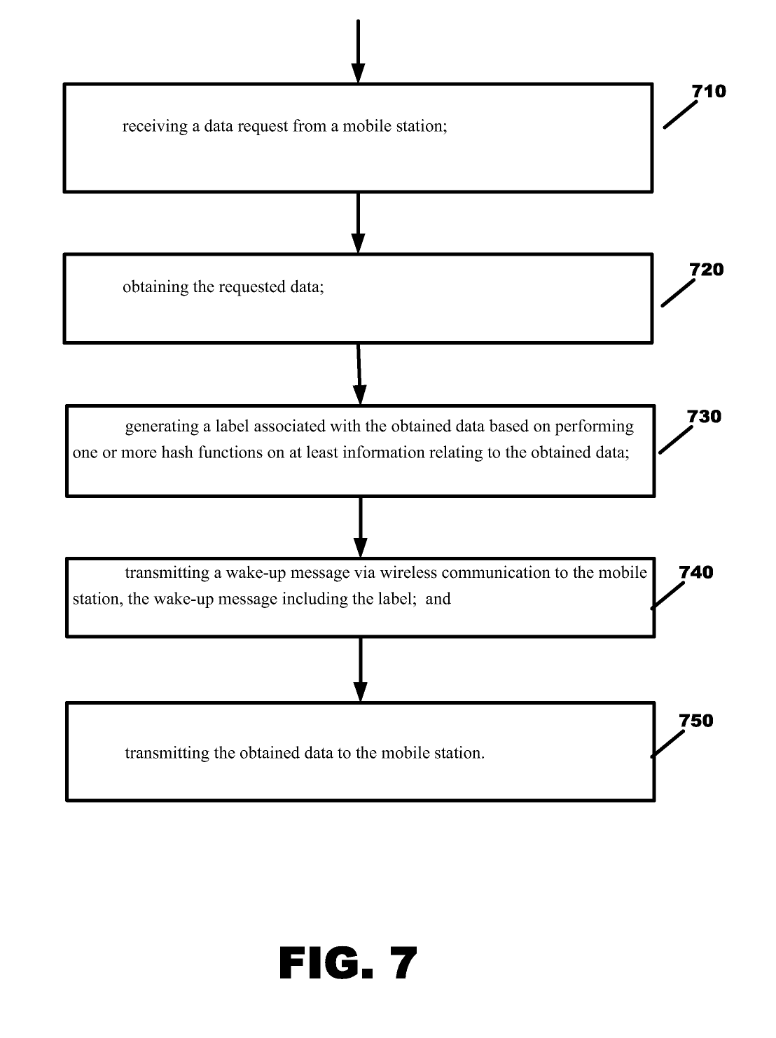

FIG. 7 is a flow chart illustrating operation of a responding station according to an example embodiment. Operation 710 may include receiving a data request from a mobile station. Operation 720 may include obtaining the requested data. Operation 730 may include generating a label associated with the obtained data based on performing one or more hash functions on at least information relating to the obtained data. Operation 740 may include transmitting a wake-up message via wireless communication to the mobile station, the wake-up message including the label. Operation 750 may include transmitting the obtained data to the mobile station.

The method of FIG. 7 may further include comparing the generated label to a set of one or more active labels, each active label associated with an outstanding data request for the mobile station; determining that the generated label matches one of the one or more active labels based on the comparing; wherein the transmitting the wake-up message and the transmitting the obtained data are performed in response to the determining.

In the method of FIG. 7, the obtaining (720) the requested data may include: receiving a data identifier in the data request; and retrieving the requested data based on the data identifier.

In an example embodiment of the method of FIG. 7, the data identifier may include one or more of the following: a sender email address; identification information for an audio, video or text file; a network address or URI (Uniform Resource Identifier) from which data is to be retrieved; or a search string for which search results are being requested.

In the method of FIG. 7, transmitting a wake-up message may include broadcasting a beacon via wireless communication, the beacon including at least an identifier identifying the mobile station and the label.

In the method of FIG. 7, the generating a label may include: generating a label associated with the obtained data based on performing one or more hash functions on at least information relating to the obtained data; comparing the generated label to a set of one or more active labels, each active label associated with an outstanding data request for the mobile station; and determining that the generated label matches one of the one or more active labels based on the comparing.

According to an example embodiment, an apparatus may include means (e.g., data communication module and/or processor 214) for receiving a data request from a mobile station, means (e.g., data communication module and/or processor 214) for obtaining the requested data, means (e.g., processor 214 and/or a Bloom filter, such as filter 220) for generating a label associated with the obtained data based on performing one or more hash functions on at least information relating to the obtained data, means (e.g., data communication module and/or processor 214) for transmitting a wake-up message via wireless communication to the mobile station, the wake-up message including the label, and means for (e.g., data communication module and/or processor 214) transmitting the obtained data to the mobile station.

The apparatus may further include means (e.g., processor 214 and/or Bloom filter 220) for comparing the generated label to a set of one or more active labels (e.g., active labels that may be stored in counting Bloom filter 220), each active label associated with an outstanding data request for the mobile station; means (e.g., processor 214) for determining that the generated label matches one of the one or more active labels based on the comparing; wherein the transmitting the wake-up message and the transmitting the obtained data are performed in response to the determining.

According to an example embodiment, an apparatus may include: at least one processor; at least one memory including computer program code, the at least one memory and the computer program code configured to, with the at least one processor cause the apparatus to at least: receive a data request from a mobile station; obtain the requested data; generate a label associated with the obtained data based on performing one or more hash functions on at least information relating to the obtained data; transmit a wake-up message via wireless communication to the mobile station, the wake-up message including the label; and transmit the obtained data to the mobile station.

In the apparatus, the at least one memory and the computer program code further configured to, with the at least one processor cause the apparatus to: compare the generated label to a set of one or more active labels, each active label associated with an outstanding data request for the mobile station; determine that the generated label matches one of the one or more active labels based on the comparing.

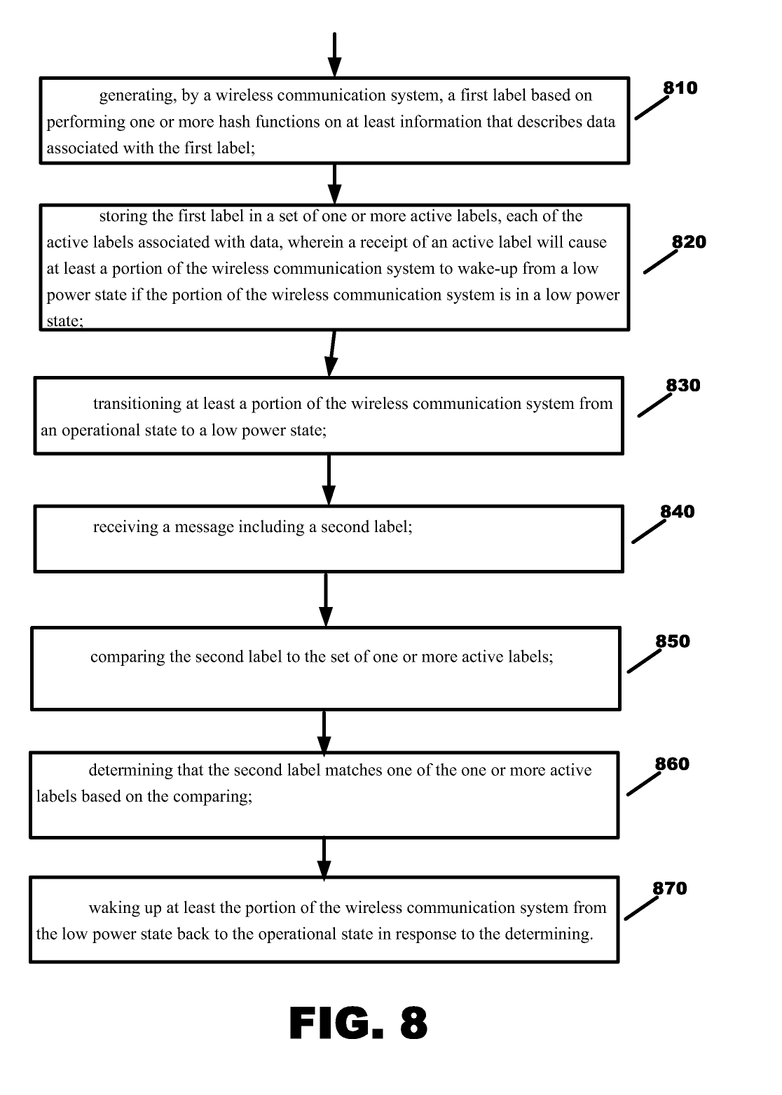

FIG. 8 is a flow chart illustrating operation of a requesting or receiving station (e.g., MS), according to another example embodiment. In this example embodiment, the MS (or requesting/receiving station) may or may not transmit a data request to the BS or responder station. Rather, data may be obtained by the responder station, and a second label may be generated for the obtained data. A wake-up message may be sent to the MS or receiving station including the second label. A wake-up of at least a portion of the apparatus or communication system (e.g., that is in low power state) of the receiving station may be performed if the received second label matches a set of active labels stored at the receiving station, according to an example embodiment.

Operation 810 may include generating, by a wireless communication system, a first label based on performing one or more hash functions on at least information that describes data associated with the first label. Operation 820 may include storing the first label in a set of one or more active labels, each of the active labels associated with data, wherein a receipt of an active label will cause at least a portion of the wireless communication system to wake-up from a low power state if the portion of the wireless communication system is in a low power state. Operation 830 may include transitioning at least a portion of the wireless communication system from an operational state to a low power state. Operation 840 may include receiving a message including a second label. Operation 850 may include comparing the second label to the set of one or more active labels. Operation 860 may include determining that the second label matches one of the one or more active labels based on the comparing. Operation 870 may include waking up at least the portion of the wireless communication system from the low power state back to the operational state in response to the determining.

According to an example embodiment, an apparatus may include means (e.g., processor 214 and/or a Bloom filter, such as filter 220) for generating, by a wireless communication system, a first label based on performing one or more hash functions on at least information that describes data associated with the first label; means (e.g., processor 214 and/or filter 220 and/or memory 216) for storing the first label in a set of one or more active labels (e.g., active labels may be stored in a counting Bloom filter 220 as an example), each of the active labels associated with data, wherein a receipt of an active label will cause at least a portion of the wireless communication system to wake-up from a low power state if the portion of the wireless communication system is in a low power state; means (e.g., processor 214 and/or data communication module 212) for transitioning at least a portion of the wireless communication system (e.g., portion of system 200) from an operational state to a low power state; means (e.g., wake-up module 210) for receiving a message including a second label; means (e.g., including wake-up module 210) for comparing the second label to the set of one or more active labels (e.g., active labels may be stored as Bloom filter 220, as an example, or in memory, or within wake-up module); means (e.g., wake-up module 210) for determining that the second label matches one of the one or more active labels based on the comparing; and means (e.g., wake-up module 210) for waking up (e.g., by outputting a wake-up signal to a portion of system 200) at least the portion of the wireless communication system from the low power state back to the operational state in response to the determining.

In addition, a storage medium may be provided that includes stored instructions, which when executed by a controller or processor may result in a processor (e.g., 214 and/or included within 212), or other controller or processor, performing one or more of the functions or tasks described herein.

Referring to FIG. 2 again, wireless communication system 200 may also be provided at a base station (BS), but typically would not include the wake-up module 210 for a base station/Access Point. For a BS, the wireless communication system 200 may also typically include at least one wired network interface (not shown in FIG. 2), such as an Ethernet network interface to allow the BS to communicate over a wired network, such as over the Internet or other network.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
generating, by a first wireless communication system, a first label based on performing one or more hash functions on at least information relating to data to be requested;
storing the first label in a set of one or more active labels;
transmitting a data request to request the data;
transitioning at least a portion of the first wireless communication system from an operational state to a low power state;
receiving a message including a second label;
comparing the second label to the set of one or more active labels, each of the active labels associated with an outstanding data request;
determining that the second label matches one of the one or more active labels based on the comparing;
waking up at least the portion of the first wireless communication system from the low power state back to the operational state in response to the determining.

2. The method of claim 1 and further comprising, after the waking, receiving, at least the requested data.

3. The method of claim 1 wherein the message comprises the requested data.

4. The method of claim 1 wherein the generating comprises:
generating, by the first wireless communication system, a first label based on performing one or more hash functions using a Bloom filter on at least information relating to data to be requested.

5. The method of claim 1 wherein the storing the first label comprises storing, by the first wireless communication system, the first label in a counting Bloom filter.

6. The method of claim 1 wherein the receiving comprises receiving a wake-up message including the second label, the wake-up message indicating that data associated with the second label will be transmitted.

7. The method of claim 1 wherein the requested data comprises one or more of the following:
email(s) from one or more sender email addresses;
a web page from a particular address or associated with a particular URI;
an audio file;
a video file; or
search results based on a particular search string.

8. The method of claim 1 wherein the generating a first label comprises:
generating, by a first wireless communication system, a first label based on performing one or more hash functions on at least information relating to data to be requested, the information relating to data to be requested comprising one or more of:
a sender email address;
identification information for an audio, video or text file;
a network address or URI (Uniform Resource Identifier) from which data is to be retrieved;
a search string for which search results are being requested;
an identifier of a sender of the data request, or an identifier of a receiver of the data request;
an address of the sender of the data request, or an address of the receiver of the data request; or
an identification of one or more protocol stacks used to generate the data request.

9. An apparatus comprising:
at least one processor;
at least one memory including computer program code, the at least one memory and the computer program code configured to, with the at least one processor cause the apparatus to at least:
generate a first label based on performing one or more hash functions on at least information relating to data to be requested;
store the first label in a set of one or more active labels;
transmit a data request message to request the data; and
transition at least a portion of the apparatus from an operational state to a low power state; and
a wake-up module, the wakeup module configured to.
receive a message including a second label;
compare the second label to the set of one or more active labels, each of the active labels associated with an outstanding data request;
determine that the second label matches one of the one or more active labels based on the comparing;
wake-up at least the portion of the apparatus from the low power state back to the operational state in response to the determining.

10. The apparatus of claim 9 wherein the apparatus being further configured to receive the requested data after the waking up at least the portion of the apparatus.

11. The apparatus of claim 9 wherein the message comprises the requested data.

12. The apparatus of claim 9 wherein the at least one memory and the computer program code configured to, with the at least one processor to cause the apparatus to generate comprises being configured to cause the apparatus to:
generate a first label based on performing one or more hash functions using a Bloom filter on at least information describing the data to be requested.

13. The apparatus of claim 9 wherein the at least one memory and the computer program code configured to, with the at least one processor to cause the apparatus to store the first label comprises being configured to cause the apparatus to: store the first label in a counting Bloom filter.

14. The apparatus of claim 9 wherein the wakeup message includes the second label and indicates that data associated with the second label will be transmitted.

15. The apparatus of claim 9 wherein the requested data comprises one or more of the following:
email(s) from one or more sender email addresses;
a web page from a particular address or associated with a particular URI;
an audio file;
a video file; or
search results based on a particular search string.

16. The apparatus of claim 9 wherein the information relating to data to be requested comprises one or more of:
a sender email address;
identification information for an audio, video or text file;
a network address or URI (Uniform Resource Identifier) from which data is to be retrieved; or
a search string for which search results are being requested.

17. A method comprising:
receiving a data request from a mobile station;
obtaining the requested data;
generating a label associated with the obtained data based on performing one or more hash functions on at least information relating to the obtained data;
transmitting a wake-up message to the mobile station, the wake-up message including the label; and
transmitting the obtained data to the mobile station.

18. The method of claim 17 and further comprising:
comparing the generated label to a set of one or more active labels, each active label associated with an outstanding data request for the mobile station;
determining that the generated label matches one of the one or more active labels based on the comparing;
wherein the transmitting the wake-up message and the transmitting the obtained data are performed in response to the determining.

19. The method of claim 17 wherein the obtaining the requested data comprises:
receiving a data identifier in the data request; and
retrieving the requested data based on the data identifier.

20. The method of claim 19 wherein the data identifier comprises one or more of the following:
a sender email address;
identification information for an audio, video or text file;
a network address or URI (Uniform Resource Identifier) from which data is to be retrieved; or
a search string for which search results are being requested.

21. The method of claim 17 wherein the transmitting a wake-up message comprises broadcasting a beacon, the beacon including at least an identifier identifying the mobile station and the label.

22. The method of claim 17 wherein the generating a label comprises:
generating a label associated with the obtained data based on performing one or more hash functions on at least information relating to the obtained data;
comparing the generated label to a set of one or more active labels, each active label associated with an outstanding data request for the mobile station; and
determining that the generated label matches one of the one or more active labels based on the comparing.

23. An apparatus comprising:
at least one processor;
at least one memory including computer program code, the at least one memory and the computer program code configured to, with the at least one processor cause the apparatus to at least:
receive a data request from a mobile station;
obtain the requested data;
generate a label associated with the obtained data based on performing one or more hash functions on at least information relating to the obtained data;
transmit a wake-up message to the mobile station, the wake-up message including the label; and
transmit the obtained data to the mobile station.

24. The apparatus of claim 23 and the at least one memory and the computer program code further configured to, with the at least one processor cause the apparatus to:
compare the generated label to a set of one or more active labels, each active label associated with an outstanding data request for the mobile station;
determine that the generated label matches one of the one or more active labels based on the comparing.

25. A method comprising:
generating, by a wireless communication system, a first label based on performing one or more hash functions on at least information that describes data associated with the first label;
storing the first label in a set of one or more active labels, each of the active labels associated with data, wherein a receipt of an active label will cause at least a portion of the wireless communication system to wake-up from a low power state if the portion of the wireless communication system is in a low power state;
transitioning at least a portion of the wireless communication system from an operational state to a low power state;
receiving a message including a second label;
comparing the second label to the set of one or more active labels;
determining that the second label matches one of the one or more active labels based on the comparing;
waking up at least the portion of the wireless communication system from the low power state back to the operational state in response to the determining.
